(19) United States
(12) Patent Application Publication
(10) Pub. No.: US 2010/0138672 A1
(43) Pub. Date: Jun. 3, 2010

(54) RAID CONTROLLER, STORAGE CONTROL DEVICE, AND STORAGE CONTROL METHOD

(75) Inventors: Hiromitsu HORIE, Tokyo (JP); Hiroki Nakajima, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/576,420

(22) Filed: Oct. 9, 2009

(30) Foreign Application Priority Data
Dec. 2, 2008 (JP) 2008-307067

(51) Int. Cl. G06F 11/30; H04K 1/00

(52) U.S. Cl. 713/193; 711/114

(57) ABSTRACT

A RAID controller selecting a plurality of storages forming RAID includes a data input part having a plurality of data input terminals; a control signal input part having a control signal input terminal to which a control signal related to path setting is inputted; a data output part having a plurality of data output terminals; and a path selection part connecting a data input terminal selected from among the plurality of data input terminals with a data output terminal selected from among the plurality of data output terminals based on the control signal when the control signal is inputted to the control signal input terminal.

### CROSS-REFERENCE TO RELATED APPLICATIONS

This application is based upon and claims the benefit of priority from the prior Japanese Patent Application No. 2008-307067 filed on Dec. 2, 2008, the entire contents of which are incorporated herein by reference.

### BACKGROUND

1. Field

This invention relates to RAID controllers selecting a plurality of storages forming RAID, storage control devices, and storage control methods.

2. Description of the Related Art

Conventionally, RAID (Redundant Arrays of Inexpensive Disks) technology of combining a plurality of storages into one storage and managing the one storage is known, and a storage control device is known as a device for controlling the plurality of storages forming the RAID.

The storage control device has a RAID controller which selects a plurality of storages. Japanese Laid-open Patent Publication No. 2006-319589 discloses a technique of providing a storage control device with an encryption circuit and encrypting write data without failure.

Moreover, Japanese Laid-open Patent Publication No. 2006-260491 discloses a technique of providing each storage with an encryption circuit and making it possible to choose whether or not to encrypt write data.

### SUMMARY

According to an aspect of the embodiment, a RAID controller selecting a plurality of storages forming RAID includes a data input part having a plurality of data input terminals; a control signal input part having a control signal input terminal to which a control signal related to path setting is inputted; a data output part having a plurality of data output terminals; and a path selection part connecting a data input terminal selected from among the plurality of data input terminals with a data output terminal selected from among the plurality of data output terminals based on the control signal when the control signal is inputted to the control signal input terminal, wherein when the control signal indicates an instruction to store data to be stored in a target storage, the path selection part selects a data input terminal to which encrypted data obtained by encrypting the data to be stored is inputted and a data output terminal producing an output to the target storage and connects the data input terminal with the data output terminal, and when the control signal indicates an instruction to write invalidation data invalidating stored data in the target storage, the path selection part selects a data input terminal to which the invalidation data are inputted and the data output terminal and connects the data input terminal with the data output terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 is an explanatory diagram of path selection performed by a storage control device;

FIG. 2 is a block diagram of a hardware configuration of a storage control device 100 in accordance with an embodiment;

FIG. 3 is a block diagram of a functional configuration of the storage control device 100;

FIG. 4A is an explanatory diagram of an example in which encrypted data are selected by a path selection circuit 101;

FIG. 4B is an explanatory diagram of an example in which invalidation data are selected by the path selection circuit 101;

FIG. 5 is a sequence diagram of write instruction processing when write data are data to be stored;

FIG. 6 is a sequence diagram of write instruction processing when write data are invalidation data;

FIG. 7 is a flow chart of a control procedure of the storage control device 100;

FIG. 8 is a flow chart of a procedure of data writing processing;

FIG. 9 is a flow chart of a procedure of writing check processing; and

FIG. 10 is a flow chart of a procedure of data rewriting processing.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereinafter, with reference to the drawings, a preferred embodiment of a storage control device will be described in detail.

### (Outline of the Embodiment)

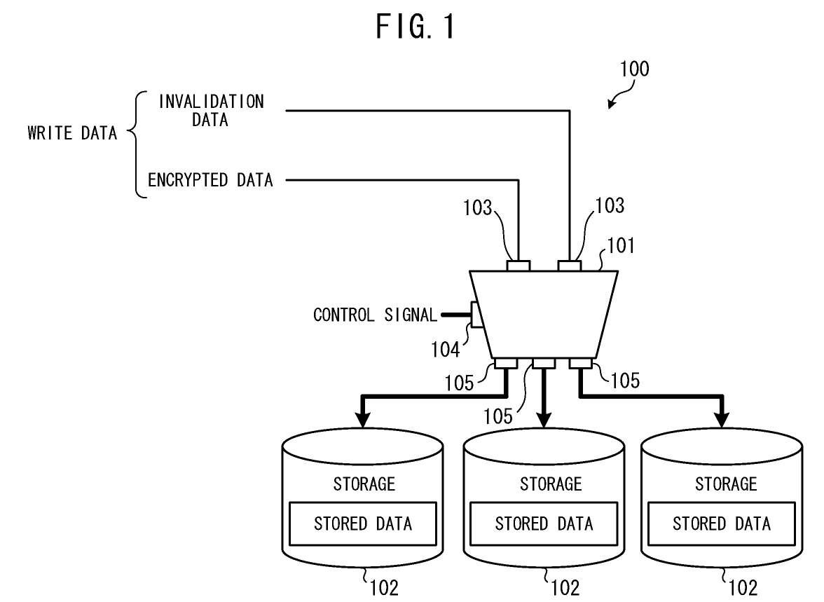

In this embodiment, it is possible to switch from storing of data in a storage to the function of disabling reconstruction of encrypted data in all the storages by selecting a path by which encrypted data obtained by encrypting data to be stored by an encryption circuit are written into a target storage and a path by which invalidation data are written over all the storages without encrypting the invalidation data. In FIG. 1, an example of path selection is illustrated.

FIG. 1 is an explanatory diagram of path selection performed by a storage control device. Data in a storage 102 is stored data. A path selection circuit 101 in a storage control device 100 outputs either encrypted data or invalidation data based on a control signal. The encrypted data are data to be stored that are encrypted by an encryption circuit

The path selection circuit 101 has data input terminals 103, a control signal input terminal 104, and a data output terminal 105. First, invalidation data and encrypted data are inputted to the data input terminals 103, and a control signal is inputted to the control signal input terminal 104. Then, based on the control signal, any one of the data input terminals 103 is connected to the data output terminal 105. Then, the data outputted from the path selection circuit 101 are written into the storage 102.

Moreover, the stored data are encrypted data stored in the storage 102. For example, the stored data are a text file, image data, and audio data.

The invalidation data are data for invalidating the stored data in the storage 102, and are data that are not encrypted. Specifically, the invalidation data are data that can clear the stored data in the storage 102 by rewriting the value in the storage 102 into a specific value. For example, the invalidation data are data that writes 0 or 1 in the values of all the addresses. As a result of all data in the storage being overwritten with 0 or 1 data, it becomes easy to check whether or not reconstruction of the stored data in the storage 102 has been disabled.

### (Hardware Configuration of the Storage Control Device 100)

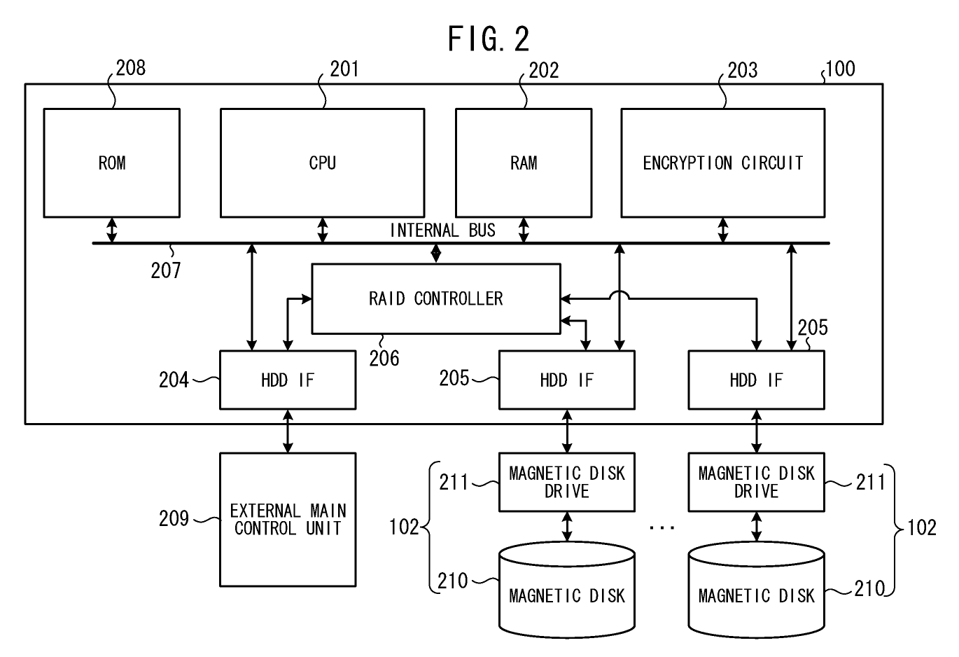

FIG. 2 is a block diagram of a hardware configuration of the storage control device 100 in accordance with the embodiment. In FIG. 2, the storage control device 100 has a CPU (Central Processing Unit) 201, a RAM (Random Access Memory) 202, an encryption circuit 203, an HDD IF (Hard Disk Drive InterFace) 204, an HDD IF (Hard Disk Drive InterFace) 205, a RAID controller 206, and a ROM (Read-Only Memory) 208. Moreover, the component parts are connected to one another by an internal bus 207.

Furthermore, the storage 102 is a storage device for storing data. In this embodiment, an example of the storage 102 is a magnetic disk 210 and a magnetic disk drive 211; however, the storage 102 may be, for example, a storage on which write operation can be performed more than once, such as an optical disk and an optical disk drive, a magnetic tape and a driver for a magnetic tape, or a flash memory.

Here, the CPU 201 performs overall control of the storage control device 100. The ROM 208 stores a storage control program. The RAM 202 is used as a work area of the CPU 201.

The RAID controller 206 selects a designated target storage 102 from among a plurality of storages 102. Furthermore, the RAID controller 206 selects data to be written into the target storage 102.

The HDD IF 204 is a buffer that can hold an instruction and write data. The HDD IF 204 outputs a stored instruction to the CPU 201, and outputs stored write data to the RAID controller 206. The HDD IF 205 is a buffer that can hold read/write data and control. Under the control of the RAID controller 206 and the CPU 201, the HDD IF 205 outputs read/write data or control to the magnetic disk drive 211.

The magnetic disk drive 211 controls reading/writing of data from/into the magnetic disk 210 under the control of the CPU 201 and the RAID controller 206. The magnetic disk 210 stores data written thereinto under the control of the magnetic disk drive 211.

An external main control unit 209 inputs a write instruction and write data to the storage control device 100. As the external main control unit 209, a scanner, a printer, or a keyboard, for example, may be connected to the storage control device 100. Then, under the control of the CPU 201, the encryption circuit 203 encrypts the data inputted from the external main control unit 209.

### (A Functional Configuration of the Storage Control Device 100)

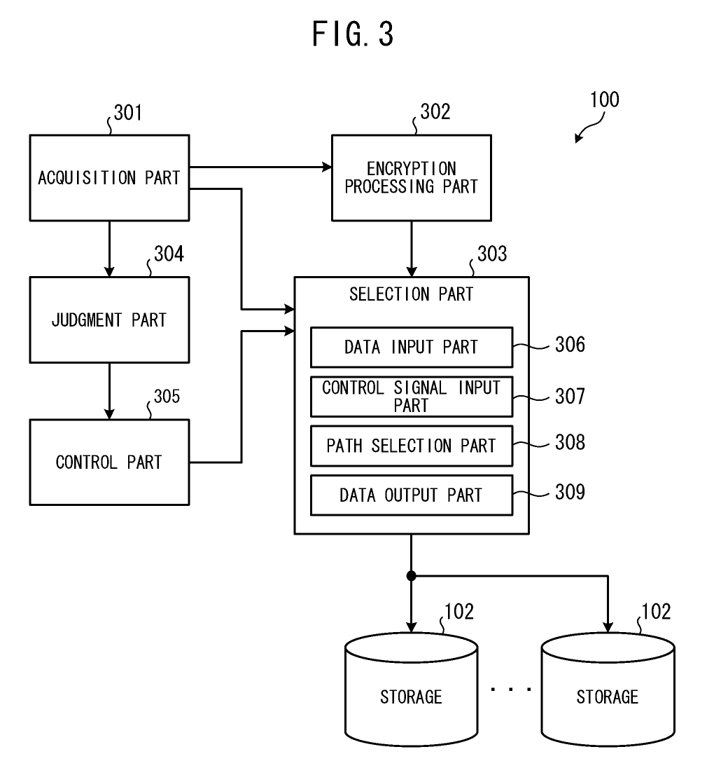

Next, a functional configuration of the storage control device 100 will be described. FIG. 3 is a block diagram of a functional configuration of the storage control device 100. The storage control device 100 includes an acquisition part 301, an encryption processing part 302, a selection part 303, a judgment part 304, and a control part 305. Specifically, the judgment part 304 and the control part 305 realize the functions thereof by, for example, making the CPU 201 execute the storage control program stored in a storage device such as the ROM 208 or RAM 202 are illustrated in FIG. 2.

First, the acquisition part 301 has the function of acquiring a write instruction and write data from the external main control unit 209. Specifically, for example, the HDD IF 204 receives the write instruction and the write data from the external main control unit 209. Moreover, after the write instruction is received by the HDD IF 204, the CPU 201 may read the write data from a storage device such as the RAM 202 or ROM 208.

The encryption processing part 302 has the function of encrypting the write data acquired by the acquisition part 301 when the write data are inputted. Specifically, for example, when the acquired write data are inputted to the encryption circuit 203 via the RAID controller 206, the encryption circuit 203 encrypts the write data. Then, the encryption circuit 203 outputs the encrypted data to the RAID controller 206.

The selection part 303 has the function of selecting either the write data acquired by the acquisition part 301 or the encrypted data encrypted by the encryption circuit 203 and outputting the selected data. Specifically, the path selection circuit 101 in the RAID controller 206 selects either the invalidation data or the encrypted data inputted to the data input terminals 103. Next, the selection part 303 connects the data input terminal 103 for the selected data with the data output terminal 105. The selection part 303 includes a data input part 306, a control signal input part 307, a path selection part 308, and a data output part 309.

Moreover, a case in which the encrypted data are selected by the selection part 303 is referred to as a first path, and a case in which the invalidation data are selected by the selection part 303 is referred to as a second path.

The data input part 306 inputs, to the data input terminal 103, the encrypted data which is the write data acquired by the acquisition part 301 and encrypted through the encryption processing part 302, and inputs the invalidation data which has not passed through the encryption processing part 302 to the data input terminal 103. Specifically, for example, the write data from the HDD IF 204 and the encrypted data which is the write data encrypted by the encryption circuit 203 are inputted to the data input terminals 103.

The control signal input part 307 inputs an input of a control signal outputted from the control part 305, which will be described later, to the control signal input terminal 104. Specifically, for example, a control signal outputted from the CPU 201 is inputted to the control signal input terminal 104 of the path selection circuit 101.

The path selection part 308 selects either the encrypted data or the invalidation data inputted from the data input part 306 based on the control signal inputted from the control signal input part 307. Then, the path selection part 308 connects the data input terminal 103 for the selected data with the data output terminal 105 of the output part 309, which will be described later.

Specifically, for example, the path selection circuit 101 in the RAID controller 206 selects either the inputted invalidation data or the inputted encrypted data. For example, when the control signal is 0, the path selection circuit 101 selects the encrypted data, and connects the data input terminal 103 for the encrypted data with the data output terminal 105 producing an output to the storage of the output part 309, which will be described later. On the other hand, when the control signal is 1, the selection circuit 101 selects the invalidation data, and connects the data input terminal 103 for the invalidation data with the data output terminal 105 producing an output to the storage of the output part 309, which will be described later.

Moreover, when the write data are data to be stored, the path selection part 308 connects the data input terminal 103 for the write data which has not passed through the encryption processing part 302 with the data output terminal 105 producing an output to the encryption processing part 302. Specifically, for example, when the control signal is 0, the path selection part 308 connects the data input terminal 103 to which the data to be stored is inputted with the data output terminal 105 producing an output to the encryption circuit 203.

This makes it possible to choose whether or not to encrypt the write data based on the write instruction. As a result, when the write data are invalidation data, it is possible to skip processing by the encryption circuit 203. This helps reduce the time for processing the write instruction.

Next, the data output part 309 makes the data output terminal 105 output data to the storage. Specifically, for example, the data output terminal 105 outputs either the encrypted data or the invalidation data selected by the path selection circuit 101 to the storage.

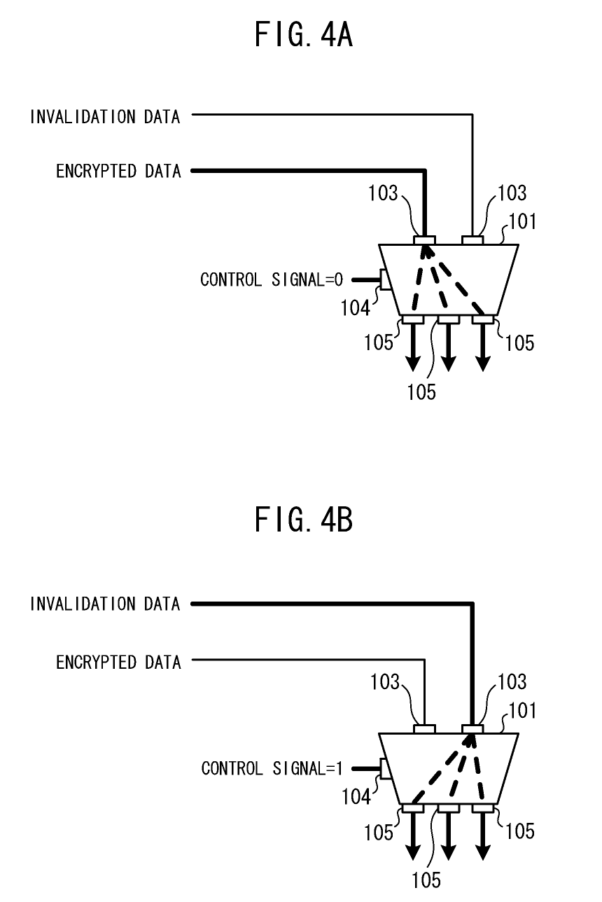

Furthermore, the data output part 309 makes the data output terminal 105 output data to the encryption processing part 302. Specifically, for example, the data output terminal 105 outputs data to be stored of the data input terminal 103 to which the data output terminal 105 is connected, the data input terminal 103 to which the data to be stored is inputted, to the encryption circuit 203. In FIG. 4A, an example in which the encrypted data are selected is illustrated.

FIG. 4A is an explanatory diagram of an example in which the encrypted data are selected by the path selection circuit 101. Since the control signal is 0, the encrypted data are selected by the path selection circuit 101 as data to be written into the storage 102. Then, the data input terminal 103 to which the encrypted data are inputted is connected to the data output terminal 105. In FIG. 4B, an example in which the invalidation data are selected is illustrated.

Moreover, for example, when the first path is selected, the RAID controller 206 selects a target storage 102 in which data to be stored is to be stored from among a plurality of storages by associating a write instruction with information on the storage and designating the target storage 102.

FIG. 4B is an explanatory diagram of an example in which the invalidation data are selected by the path selection circuit 101. Since the control signal is 1, the invalidation data are selected by the path selection circuit 101 as data to be written into the storage 102. Then, the data input terminal 103 to which the invalidation data are inputted is connected to the data output terminal 105.

Moreover, when the second path is selected, the RAID controller 206 (shown in FIG. 2) sets all the storages 102 as a target storage 102 for the invalidation data, whereby it is possible to disable reconstruction of the stored data of all the storages 102 by executing an invalidation data write instruction once. This makes it possible to save the effort of executing an invalidation data write instruction more than once.

Back in FIG. 3, based on the write instruction acquired by the acquisition part 301, the judgment part 304 judges whether the write data are data to be stored in a target magnetic disk 210 or invalidation data invalidating the stored data in the target magnetic disk 210.

Specifically, for example, the CPU 201 (shown in FIG. 2) decodes a code of the write instruction by an instruction decoder in the CPU 201. Then, the CPU 201 identifies the type of write instruction based on the result of decoding, and judges whether the write data are data to be stored or invalidation data. Incidentally, the result of judgment is stored in a storage device such as the RAM 202.

The control part 305 controls the selection part 303 so as to select the first path when the judgment part 304 judges that the write data are data to be stored, and to select the second path when the judgment part 304 judges that the write data are invalidation data. Specifically, for example, when the write data are judged to be data to be stored based on the result obtained by the instruction decoder, the CPU 201 sets the control signal which is an input signal of the path selection circuit 101 of the RAID controller 206 to 0. On the other hand, when the write data are judged to be invalidation data, the CPU 201 sets the control signal to 1. Next, the CPU 201 outputs the control signal to the RAID controller 206.

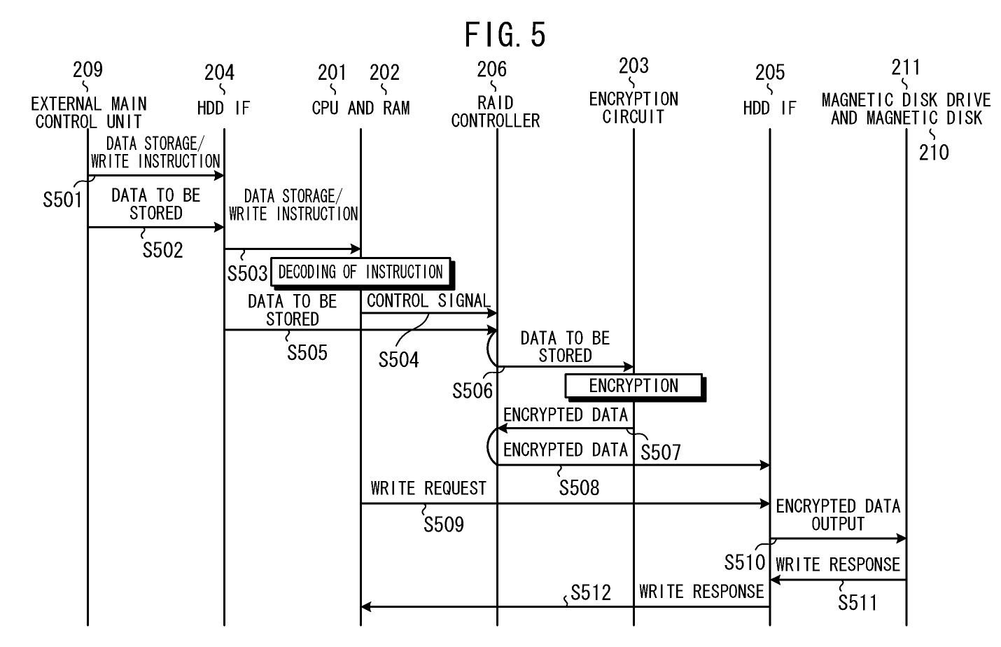

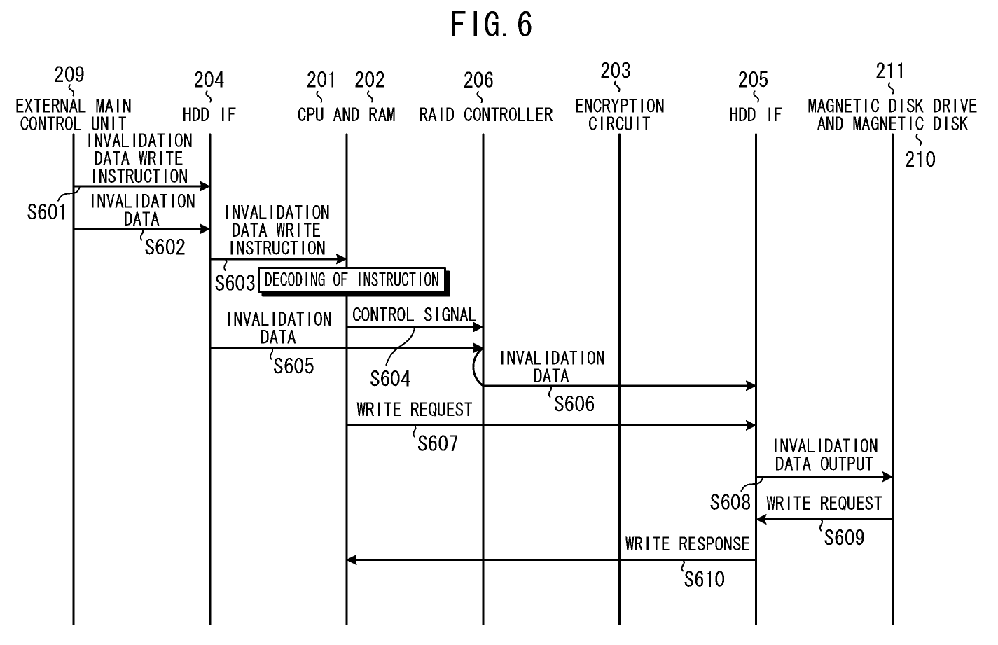

In the case of the first path, regardless of which storage 102 is selected, the write data are encrypted by a path passing through the encryption processing part 302. In the case of the second path, as a result of the stored data in the target magnetic disk 210 being overwritten with the invalidation data, reconstruction of the stored data are disabled. This helps improve the security and achieve a price reduction. Next, in FIGS. 5 and 6, write instruction processing is illustrated by using a sequence diagram.

First, FIG. 5 is a sequence diagram of write instruction processing when the write data are data to be stored. First, a data storage/write instruction is inputted from the external main control unit 209 to the HDD IF 204 (operation S501), and data to be stored is then inputted (operation S502). Next, the HDD IF 204 outputs the data storage/write instruction to the CPU 201 and the RAM 202 (operation S503). Then, the CPU 201 decodes the data storage/write instruction. Next, the CPU 201 judges that the data associated with the write instruction is data to be stored, and sets the control signal to 0. Then, the CPU 201 outputs the control signal to the RAID controller 206 (operation S504).

Next, the data to be stored is inputted from the HDD IF 204, via the RAID controller 206 (operation S505), to the encryption circuit 203 (operation S506). Then, the data to be stored is encrypted by the encryption circuit 203. The encrypted data are inputted, via the RAID controller 206 (operation S507), to the HDD IF 205 (operation S508). Next, when a write request is outputted from the CPU 201 to the HDD IF 205 (operation S509), the encrypted data are outputted from the HDD IF 205 to the magnetic disk drive 211 (operation S510).

Furthermore, when the encrypted data are written into the magnetic disk 210 by the magnetic disk drive 211, the magnetic disk drive 211 inputs a write response to the HDD IF 205 (operation S511). Then, the HDD IF 205 outputs the write response to the CPU 201 (operation S512), and ends the write instruction processing.

As a result, regardless of which target storage 102 is selected, the write data are encrypted by a path passing through the encryption circuit 203. The storage control device 100 does not need to hold the encryption circuit 203 for each storage 102. This helps achieve a price reduction.

FIG. 6 is a sequence diagram of write instruction processing when the write data are invalidation data. First, an invalidation data write instruction is inputted from the external main control unit 209 to the HDD IF 204 (operation S601), and invalidation data are then inputted (operation S602). Next, the HDD IF 204 outputs the invalidation data write instruction to the CPU 201 and the RAM 202 (operation S603). Then, the CPU 201 decodes the invalidation data write instruction. Next, the CPU 201 judges that the data associated with the write instruction is invalidation data, and sets the control signal to 1. Then, the CPU 201 outputs the control signal to the RAID controller 206 (operation S604).

Next, the invalidation data are inputted from the HDD IF 204, via the RAID controller 206 (operation S605), to the HDD IF 205 (operation S606). Next, when the CPU 201 outputs a write request to the HDD IF 205 (operation S607), the invalidation data are outputted from the HDD IF 205 to the magnetic disk drive 211 (operation S608).

Furthermore, when write processing on the magnetic disk 210 by the magnetic disk drive 211 is finished, the magnetic disk drive 211 inputs a write response to the HDD IF 205 (operation S609). Then, the HDD IF 205 outputs the write response to the CPU 201 (operation S610), and ends the write instruction processing.

Moreover, in FIG. 6, the invalidation data are inputted from the external main control unit 209. Instead, the invalidation data stored in a storage device such as the ROM 208 or RAM 202 may be accessed and read by the CPU 201.

Therefore, as a result of the stored data in the target storage 102 having been overwritten with the invalidation data, reconstruction of the stored data are disabled. Even when the data in the storage 102 is reconstructed, what is reconstructed is invalidation data. The reconstructed invalidation data are not data having a meaning, such as an image or audio, and therefore ensures the security.

### (Control Procedure of the Storage Control Device 100)

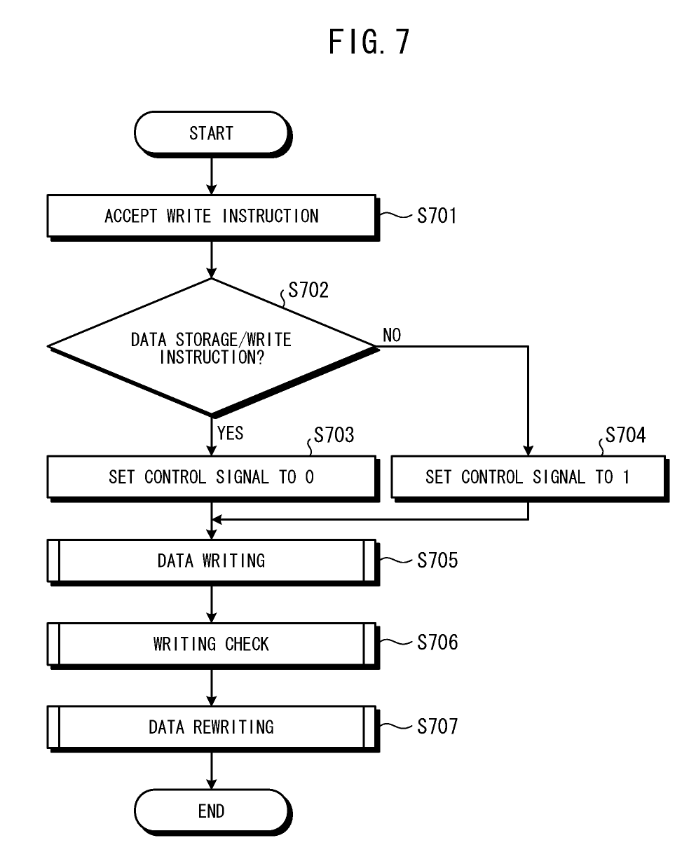

Next, a control procedure of the CPU 201 of the storage control device 100 in accordance with the embodiment will be described. FIG. 7 is a flow chart of the control procedure of the storage control device 100. In FIG. 7, first, a write instruction is accepted (operation S701), and the judgment part 304 judges whether or not the accepted write instruction is a data storage/write instruction (operation S702). If the write instruction is a data storage/write instruction (operation S702: Yes), the control part 305 sets the control signal to be given to the selection part 303 to 0 (operation S703). On the other hand, if the write instruction is not a data storage/write instruction (operation S702: No), the control part 305 sets the control signal to be given to the selection part 303 to 1 (operation S704).

Furthermore, data writing processing is performed (operation S705), and writing check processing is performed (operation S706). Then, data rewriting processing is performed (operation S707), and a series of processing is finished.

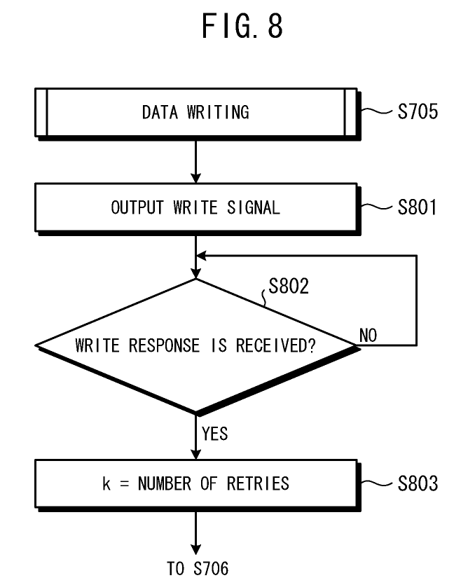

Next, the above-described data writing processing (operation S705) will be described. FIG. 8 is a flow chart of a procedure of the data writing processing. In FIG. 8, first, a write signal is outputted to the HDD IF 205 (operation S801), and, next, it is judged whether a write response is received or not (operation S802).

If a write response is not received (operation S802: No), the procedure goes back to operation S802. On the other hand, if a write response is received (operation S802: Yes), the number of retries is set to k (operation S803), and the procedure proceeds to operation S706. The number of retries is an upper limit of the number of rewrite operations when writing into the storage 102 is performed unsuccessfully.

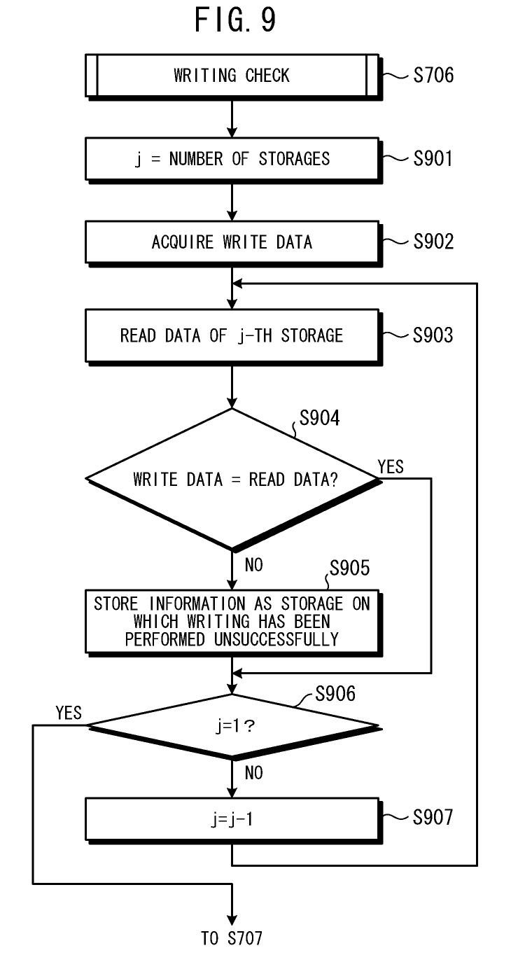

Next, the above-described writing check processing (operation S706) will be described. FIG. 9 is a flow chart of a procedure of the writing check processing. In FIG. 9, first, the number of storages is set to j (operation S901), and write data are acquired (operation S902). Data in the j-th storage 102 are read (operation S903), and it is judged whether the write data are the read data or not (operation S904). If the write data are not the read data (operation S904: No), information is stored as the storage 102 on which writing has been performed unsuccessfully (operation S905), and it is judged whether j is 1 or not (operation S906).

On the other hand, if the write data are the read data (operation S904: Yes), the procedure proceeds to operation S906. If j is not 1 (operation S906: No), processing j=j−1 is performed (operation S907), and the procedure goes back to operation S903. Moreover, if j is 1 (operation S906: Yes), the procedure proceeds to operation S707.

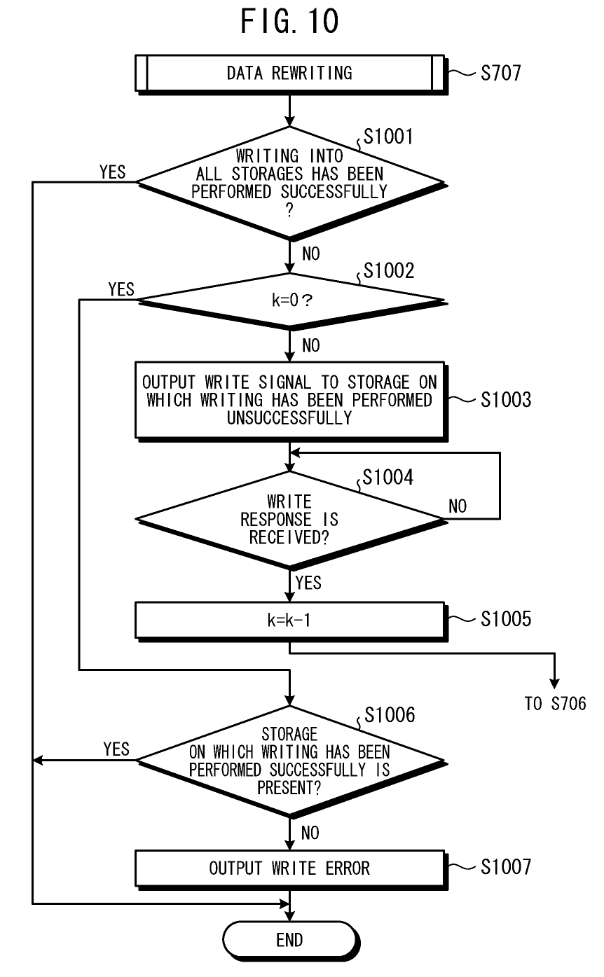

Next, the above-described data rewriting processing (operation S707) will be described. FIG. 10 is a flow chart of a procedure of the data rewriting processing. In FIG. 10, first, it is judged whether or not writing into all the storages 102 has been performed successfully (operation S1001). If writing into all the storages has not been performed successfully (operation S1001: No), it is judged whether k is 0 or not (operation S1002).

If k is not 0 (operation S1002: No), a write signal to a storage 102 on which writing has been performed unsuccessfully is outputted (operation S1003), and it is judged whether a write response is received or not (operation S1004). If a write response is not received (operation S1004: No), the procedure goes back to operation S1004. On the other hand, if a write response is received (operation S1004: Yes), calculation k=k−1 is performed (operation S1005), and the procedure goes back to operation S706.

On the other hand, if k is 0 (operation S1002: Yes), it is judged whether or not there is a storage on which writing has been performed successfully (operation S1006). If it is judged that there is no storage 102 on which writing has been performed successfully (operation S1006: No), a write error is outputted (operation S1007), and a series of processing is finished. Moreover, if it is judged that there is a storage 102 on which writing has been performed successfully (operation S1006: Yes), a series of processing is finished.

On the other hand, if it is judged that writing into all the storages 102 has been performed successfully (operation S1001: Yes), a series of processing is finished.

As described above, according to this embodiment, by switching from a path by which data to be stored is encrypted by a single encryption processing part 302 and is written into the storage 102 to a path by which invalidation data are written over the target storage 102 without encrypting the invalidation data, reconstruction of encrypted data in the target storage 102 is disabled.

Moreover, by setting all the storages 102 as a target storage 102, it is possible to disable reconstruction of the stored data in all the storages by executing an invalidation data write instruction once.

Therefore, in the case of the first path, regardless of which storage 102 is selected, it is possible to encrypt the write data by a path passing through the encryption processing part 302. In the case of the second path, as a result of the stored data in all the storages 102 being overwritten with the invalidation data, it is possible to disable reconstruction of the stored data.

As a result, by reading the data in the storage 102, it can be easily confirmed that reconstruction of the stored data are disabled. Moreover, even when the data in the storage 102 is reconstructed, what is reconstructed is invalidation data. The reconstructed invalidation data are not data having a meaning, such as an image or audio, and therefore ensures the security.

With the RAID controller 206 and the storage control device 100, it is possible to disable reconstruction of data in the magnetic disk 210 as intended efficiently, and improve the security. Moreover, a path passing through the encryption circuit 203 is used regardless of which magnetic disk 210 is selected, making it possible to obtain the effect of achieving a price reduction.

Furthermore, the storage control device 100 described in this embodiment can also be realized by an application specific IC (hereinafter referred to simply as an “ASIC”) such as a standard cell or structured ASIC (Application Specific Integrated Circuit) or a PLD (Programmable Logic Device) such as an FPGA. Specifically, for example, the functions (the acquisition part 301 to the data output part 309) of the above-described storage control device 100 are defined by an HDL, and the HDL is logically synthesized and is given to the ASIC or PLD, whereby the storage control device 100 can be produced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A RAID controller selecting a plurality of storages forming RAID, comprising:
a data input part having a plurality of data input terminals;
a control signal input part having a control signal input terminal to which a control signal related to path setting is inputted;
a data output part having a plurality of data output terminals; and
a path selection part connecting a data input terminal selected from among the plurality of data input terminals with a data output terminal selected from among the plurality of data output terminals based on the control signal when the control signal is inputted to the control signal input terminal,
wherein when the control signal indicates an instruction to store data to be stored in a target storage, the path selection part selects a data input terminal to which encrypted data obtained by encrypting the data to be stored is inputted and a data output terminal producing an output to the target storage and connects the data input terminal with the data output terminal, and
when the control signal indicates an instruction to write invalidation data invalidating stored data in the target storage, the path selection part selects a data input terminal to which the invalidation data are inputted and the data output terminal and connects the data input terminal with the data output terminal.

2. The RAID controller according to claim 1, wherein
when the control signal indicates an instruction to store data to be stored in a target storage, the path selection part selects a data input terminal to which the data to be stored is inputted and a data output terminal outputting the data to be stored to an encryption circuit and connects the data input terminal with the data output terminal.

3. A storage control device for controlling a plurality of storages forming RAID, comprising:
an acquisition unit acquiring a write instruction and write data associated with the write instruction;
an encryption unit encrypting the inputted write data;
a selection unit selecting either a first path by which the write data acquired by the acquisition unit is encrypted through the encryption unit and is outputted to a target storage or a second path by which the write data are outputted to the target storage without passing through the encryption unit;
a judgment unit judging whether the write data are data to be stored in the target storage or invalidation data invalidating stored data in the target storage based on the write instruction acquired by the acquisition unit; and
a control unit controlling the selection unit so as to select the first path when the judgment unit judges that the write data are the data to be stored, and to select the second path when the judgment unit judges that the write data are the invalidation data.

4. The storage control device according to claim 3, wherein the target storage comprises the plurality of storages.

5. The storage control device according to claim 3, wherein
the invalidation data has a value 0 or 1 as a value corresponding to all addresses of the target storage.

6. A storage control method for controlling a plurality of storages forming RAID by using a storage control device, comprising:
acquiring a write instruction and write data associated with the write instruction; and
encrypting the inputted write data;
selecting either a first path by which the write data are encrypted and are outputted to a target storage or a second path by which the write data are outputted to the target storage without being encrypted;
judging whether the write data are data to be stored in the target storage or invalidation data invalidating stored data in the target storage based on the write instruction; and
selecting the first path if the write data are the data to be stored, and selecting the second path if the write data are the invalidation data.
